(19) United States
(12) Patent Application Publication
(10) Pub. No.: US 2015/0064463 A1
(43) Pub. Date: Mar. 5, 2015

(54) GRAPHENE FIBER AND METHOD OF MANUFACTURING THE SAME

(71) Applicant: Enerage Inc., Wujie Township (TW)

(72) Inventors: Mark Y. WU, Wujie Township (TW); Cheng-Yu HSIEH, Wujie Township (TW); Jing-Ru CHEN, Wujie Township (TW); Shu-Ling HSIEH, Wujie Township (TW)

(73) Assignee: Enerage Inc., Wujie Township (TW)

(21) Appl. No.: 14/085,494

(22) Filed: Nov. 20, 2013

(30) Foreign Application Priority Data
Sep. 2, 2013 (TW) 102131586

(51) Int. Cl. C01B 31/04

(52) U.S. Cl. CPC C01B 31/0484; C01B 31/0438
USPC 428/367; 423/447.1; 423/447.7; 423/447.2

(57) ABSTRACT

The present invention discloses a graphene fiber and a method of manufacturing the same. The graphene fiber is manufactured by oxidizing graphite, dispersing, spinning, drying and heat treatment, and has a diameter less than 100 μm, a ratio of length to diameter greater than 10, and a ratio of carbon to oxygen greater than 5. The graphene fiber is formed of a plurality of graphene sheets, which envelop an axis and are coaxially stacked one by one from the axis. The thickness of the graphene sheet is less than 3 nm, and chemical bonds are formed to tightly bond the graphene sheets to exhibit excellent mechanical and thermally/electrically conductive properties. The method of the present invention is implemented by simple steps so as to greatly reduce poisonous chemicals possibly generated in the manufacturing environment, thereby improving the safety of manufacturing and reducing the whole processing time and cost.

### CROSS-REFERENCE TO RELATED APPLICATION

This application claims the priority of Taiwanese patent application No. 102131586, filed on Sep. 2, 2013, which is incorporated herewith by reference.

### BACKGROUND OF THE INVENTION

1. Field of the Invention

The present invention generally relates to a graphene fiber and a method of manufacturing the same, and more specifically to a graphene fiber comprising graphene sheets enveloping an axis and coaxially stacked one by one from the axis, and a method of manufacturing the same.

2. The Prior Arts

Carbon fiber is an excellent fiber material possessing the properties of chemical inert and semiconductor, especially light, strong with extremely high elastic modulus. For now, high performance carbon fiber material is not only applied to aviation, aerospace and national defense industries, but also widely used in the field of the vehicle body, the blades of wind electric power generator, nuclear power generator and recreational sports products. EP 1 696 046 B1 disclosed a method of preparing metal-based carbon fiber composite material by pulsed electric current sintering. The composite material exhibits excellent thermal conductivity and is applicable to dissipation parts for electronic devices or power supply modules. Additionally, US 2013/0084455 A1 entitled by “METHOD FOR THE PREPARATION OF CARBON FIBER FROM POLYOLEFIN FIBER PRECURSOR, AND CARBON FIBERS MADE THEREBY” disclosed methods for the preparation of carbon fiber from polyolefin fiber precursor. The polyolefin fiber precursor is partially sulfonated and then carbonized to produce carbon fiber so as to adjust the properties of the final products and the shape of the carbon fiber after carbonization.

As well known, graphene has a two dimensional crystalline structure with a hexagonal honeycomb arrangement bound by sp2 hybrid orbital. The thickness of graphene is generally 0.335 nm; about the diameter is only one carbon atom. It is believed graphene is the thinnest material in the world and also possesses excellent mechanical properties, like mechanical strength hundreds time higher than that of steel and specific weight about one fourth of that of steel. As for electrical properties, graphene has lower resistivity than that of copper and silver, and is known as the material with the lowest resistivity at room temperature. Electron mobility of graphene is also higher. Therefore, it is possible to anticipate that electronic devices using graphene also exhibit high performance. Especially, with the property of almost transparency and good conductivity, graphene has drawn much attention in the application field of photoelectric industry. For example, US 2012/0298396 A1 titled by “GRAPHENE FIBER, METHOD FOR MANUFACTURING SAME AND USE THEREOF” disclosed a manufacturing method of a graphene fiber, which is performed by forming a metal layer containing multiple linear patterns on a substrate; supplying a reaction gas containing a carbon source and heat to the metal layer containing multiple linear patterns to form graphenes of linear pattern; immersing the substrate in an etching solution to selectively remove the metal layer containing multiple linear patterns for separating the graphenes of linear pattern from the substrate and dispersing multiple linear graphenes into the etching solution; and pulling the dispersed multiple linear graphenes out of the etching solution to form a graphene fiber. Graphene fiber is substantially manufactured from a smaller one to a larger one. Therefore one of the shortcomings in the prior arts is that the formation rate of graphene on the metal layer is considerably slow and the CVD process usually needs some specific chemicals with certain poison. It is thus desired to provide a graphene fiber and a method of manufacturing the same to overcome the above problems in the prior arts.

### SUMMARY OF THE INVENTION

The primary objective of the present invention is to provide a graphene fiber having a diameter less than 100 μm, a ratio of length to diameter greater than 10, preferably greater than 500. One of the key advantages of the present invention over the traditional vapor grown carbon fiber (VGCF) formed by CVD or the carbon fiber formed by high temperature carbonization of polyacrylonitrile is that the graphene fiber according to the present invention generally comprises a plurality of graphene sheets having the surfaces arranged parallel to the axis of the graphene fiber, in particular, with a thickness less than 3 nm. Additionally, the graphene sheets are closely and tightly bound by chemical bonds so as to possess excellent mechanical properties, like elongation strength greater than 100 MPa and Young's modulus greater than 1 GPa.

The graphene fiber of the present invention also exhibits excellent properties of electrical and thermal conductivities such as electrical conductivity within 10⁻² to 10³ S/cm and thermal conductivity greater than 10 W/mK.

Another objective of the present invention is to provide a method of manufacturing graphene fiber comprising the steps of graphite oxidization, dispersing, spinning, drying and heat treatment. In the step of graphite oxidization, a graphite material is oxidized to form pieces of graphitic oxide. The step of dispersing is performed by dispersing the pieces of graphitic oxide in water to form a graphitic oxide solution, in which the pieces of graphitic oxide are coaxially arranged because the loose structure of the pieces of graphitic oxide is easily destroyed by dispersing. In the spinning step, the graphitic oxide solution is injected into the second solution such that graphitic oxide solution contacts the second solution to form pre-reduction graphene fiber, which is dried to separate the pre-reduction graphene fiber from the solution in the drying step. Finally, the pre-reduction graphene fiber is processed by thermal reduction in the step of heat treatment with the protective atmosphere to form graphene fiber.

The graphene fiber manufactured by the method of the present invention has excellent mechanical strength, and electrical and thermal conductivities. Therefore, the method of the present invention can be directly integrated into traditional spinning processes to obtain graphene fiber material. The whole manufacturing process is simpler and the poisonous materials generated at the working environment are greatly reduced, thereby improving the safety and decreasing the time and cost of the manufacturing process.

### BRIEF DESCRIPTION OF THE DRAWINGS

The present invention can be understood in more detail by reading the subsequent detailed description in conjunction with the examples and references made to the accompanying drawings, wherein:

FIG. 1 is a view schematically showing the graphene fiber according to the present invention;

FIG. 2 is a flowchart showing a method of manufacturing graphene fiber according to the present invention; and

FIG. 3 is a view showing the result of measuring the graphene fiber according to the present invention by the Raman spectrometry.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

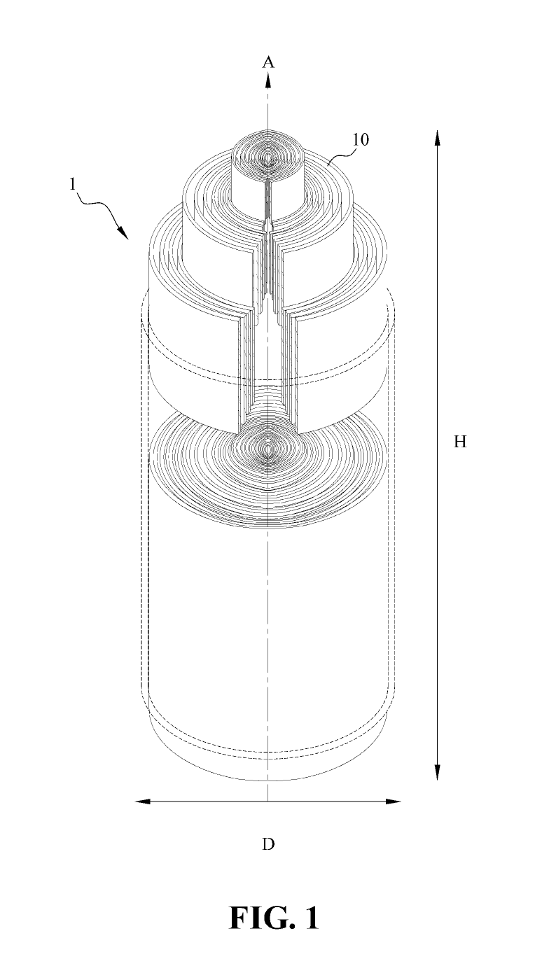

Please refer to FIG. 1. As shown in FIG. 1, the graphene fiber 1 according to the present invention comprises a plurality of graphene sheets 10 coaxially stacked one by one from the axis A of the graphene fiber 1 and extended along the axis A. Specifically, each graphene sheet 10 has a thickness less than 3 nm and envelops the axis A. The graphene sheet 10 has a diameter D less than 100 μm, a ratio (H/D) of the length H to the diameter D greater than 10, and a ratio of carbon to oxygen greater than 5.

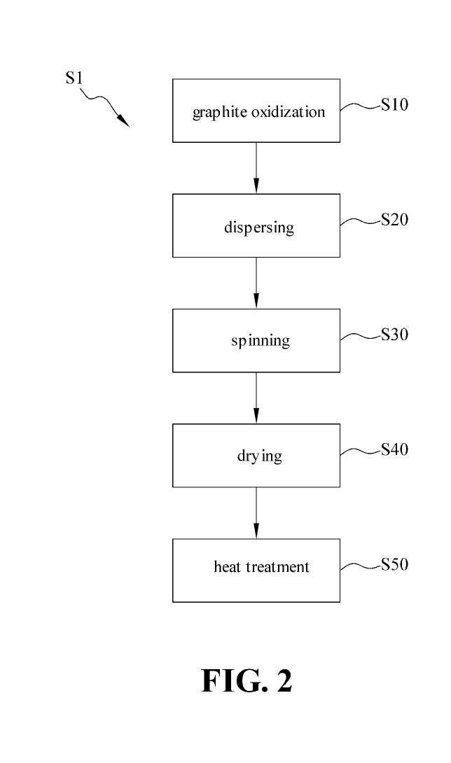

Refer to FIG. 2 showing the operational flowchart of the method of manufacturing graphene fiber according to the present invention. As shown in FIG. 2, the method of the present invention generally comprises the steps of graphite oxidization S10, dispersing S20, spinning S30, drying S40 and heat treatment S50.

More specifically, a graphite material is prepared and oxidized to form pieces of graphite oxide in the step of graphite oxidization S10. The graphite material is selected from a group consisting of at least one of natural graphite, expanded graphite, artificial graphite, graphite fiber, carbon nano-tube and mesophase carbon micro-bead. For example, the step S10 is implemented by the Hummers oxidization process. After the oxidization, a large amount of carbon oxide functional group are generated such as C—O group, C═O group, and so on. As a result, the graphite material contains considerable oxygen and forms the pieces of graphite oxide with a more swelling and looser structure.

In the step of dispersing S20, the pieces of graphitic oxide are well dispersed in water to form a graphitic oxide solution with a concentration of graphitic oxide within a range of 1 to 10 mg/ml. Since the structure of the pieces of graphitic oxide is looser, the pieces of graphitic oxide are easily separated and arranged in parallel to the direction of the long axis. Each piece of graphitic oxide has a thickness less than 3 nm. Additionally, the functional groups on the surface of graphitic oxide are dissociated and a large amount of negative charges are formed on the surface of graphitic oxide such that a repulsive force is generated among the pieces of graphitic oxide and the homogeneous graphitic oxide solution is formed. At the same time, the pieces of graphitic oxide exhibit the specific properties similar to nematic liquid crystal in such a suitable concentration so as to form a regular arrangement in one dimension.

The spinning step S30 is performed by a spinning process, like a Spunlace process or an electric spinning process, in which the graphitic oxide solution is injected into the second solution such that graphitic oxide solution contacts the second solution for at least 0.5 hour. The second solution preferably contains at least one cationic surfactant, at least one kind of cation and at least one acidic reductant such that the chemical bonds are formed between the graphene sheets. Thus, the pre-reduction graphene fiber is formed by reduction.

Owing to ordered arrangement in the graphitic oxide solution, when the pieces of graphitic oxide are injected into the second solution by a driving force, each piece of graphitic oxide is inherently arranged in parallel to the direction of the driving force. Besides, the second solution further contains the cationic surfactant and the cations such that the positive charges of the cations easily combine with the negative charges on the surface of graphene oxide so as to invoke the crosslink reaction. The chemical bonds between the pieces of graphitic oxide cause the effect of flocculation and a graphene oxide fiber is generated. The graphene oxide fiber is further chemically reducted by an acidic reductant to decrease its hydrophilic property and form a pre-reduction graphene fiber.

Specifically, the cationic surfactant has two ends, wherein one end has a hydrophobic group with a long carbon chain, and the other end has a hydrophilic group with at least one nitrogen atom, sulfur atom or phosphorus atom. Since the hydrophilic group is the surfactant with positive charges, the cationic surfactant is preferably selected from a group consisting of at least one of cetyltrimethylammonium bromide, polyacrylamide, and dodecyl trimethylammonium chloride or any combination thereof. The cation is selected from a group consisting of at least one of potassium ion, sodium ion, calcium ion, zinc ion, magnesium ion, iron ion and ammonium ion, or any combination thereof. Additionally, the acidic reductant is selected from a group consisting of at least one of ascorbic acid, citric acid, polyphenol, acetic acid, and halogen acid, or any combination thereof.

In the step S40, the pre-reduction graphene fiber taken out from the second solution and the water and/or organic solvents are well dried so as to obtain a pre-reduction graphene fiber body. The step S50 is finally performed by processing the pre-reduction graphene fiber body through heat treatment in the protective atmosphere such that the pre-reduction graphene fiber body is well processed by heat treatment to form the graphene fiber as desired. At the same time, the bonding strength between the graphene sheets is enhanced.

It is preferred that the protective atmosphere is selected from a group consisting of at least one of helium (He), argon (Ar) and nitrogen (N₂), or any combination thereof, the processing temperature of the heat treatment is within a range of 300 to 1500° C., and the processing time is within a range of 10 to 120 minutes.

By examination, the resultant graphene fiber has a ratio of carbon to oxygen (C/O) greater than 5. The graphene fiber is further tested by the Raman spectrometer to show that the ratio of intensity (I_{D}/I_{G}) is within a range of 0.5 to 1.5, and the ratio of G band intensity (I_{2D}/I_{G}) is within a range of 0.1 to 1.2.

The following experiments EX1 to EX5 are used to illustratively describe the method of manufacturing graphene fiber according the present invention. The Hummers process is used to oxidize the graphite material. First, 1 g of graphite material is added into 230 ml of sulfuric acid (H₂SO₄), and 30 g of potassium permanganate (KMnO₄) is slowly added into the mixture in an ice bath, which is continuously stirred. The temperature of the solution is kept below 20° C. during the mixing process and then the solution is further stirred for at least 40 minutes at 35° C. Next, 460 ml of deionized water is slowly mixed with the solution in the 35° C. water bath for at least 20 minutes. After the reaction, 1.4 L of deionized water and 100 ml of hydrogen peroxide (H₂O₂) are added in the solution and the mixture is still placed for 24 hours. Next, the mixture is washed by 5% hydrochloric acid (HCl), filtered and dried in the vacuum environment so as to obtain graphitic oxide powder. The graphitic oxide powder is finally mixed with deionized water to form the homogeneous graphitic oxide solution with a concentration of 10 mg/mL.

### Experiment EX1

Through the wet spinning process, 10 g/mL of the above graphitic oxide solution is injected into the cetyltrimethylammonium bromide solution with a concentration of 0.5 mg/ml under 25° C. at a speed of 10 ml/min. After 60 minutes, the graphene oxide fiber is solidified in the solution. The graphene oxide fiber is taken out from the coagulation bath by filtration and then dried at room temperature to remove the residual water so as to obtain the graphene oxide fiber body. Finally, the graphene oxide fiber body is placed in the protective atmosphere of Ar (Argon) and processed by the heat treatment with the temperature increasing up to 1500° C. at a speed of 3° C./min, and kept for 2 hours. The graphene fiber is thus obtained.

### Experiment EX2

Similarly, the wet spinning process is used to inject 10 g/ml of the graphitic oxide solution into the 0.5 mg/ml cetyltrimethylammonium bromide solution under 25° C. at 10 ml/min and the solidified graphene oxide fiber is formed after 60 minutes. Then, 10 ml of ascorbic acid with a concentration of 10 mg/ml is added and the mixture is placed in an oven at 90° C. for 4 hours so as to form the pre-reduction graphene fiber. Further, the pre-reduction graphene fiber is filtered from the coagulation bath and dried at room temperature to remove the residual water to form the pre-reduction graphene fiber body. Similarly, the pre-reduction graphene fiber body undergoes the heat treatment in the protective atmosphere of Ar to implement chemical reduction. Specifically, the heating temperature increases to 1500° C. at a heating rate of 3° C./min and kept for 2 hours so as to obtain the graphene fiber.

### Experiment EX3

The wet spinning process is performed by injecting 10 g/ml of the graphitic oxide solution into the solution containing 0.5 mg/ml polyacrylamide and 2.5 mg/ml ascorbic at 10 ml/min, and the temperature is maintained at 25° C. The mixture is still placed for 4 hours and the pre-reduction graphene fiber is solidified. Then, the pre-reduction graphene fiber is filtered from the solidifying bath and dried at room temperature to remove the residual water so as to obtain the pre-reduction graphene fiber body. Finally, the pre-reduction graphene fiber body is placed in the protective atmosphere of Ar and processed by the heat treatment with the temperature heated up to 1500° C. at a heating rate of 3° C./min and kept for 2 hours so as to obtain the graphene fiber.

### Experiment EX4

The wet spinning process is used and 10 g/mL of the graphitic oxide solution is injected into the 5 wt % copper sulfate solution at 10 ml/min. After 30 minutes, the graphene oxide fiber is solidified. The graphene oxide fiber is filtered from the coagulation bath and dried at 50° C. to remove the water so as to obtain the graphene oxide fiber body. The graphene oxide fiber body is further immersed in 2.5 mg/ml ascorbic and still placed at the oven at 90° C. for 6 hours so as to form the pre-reduction graphene fiber by chemical reduction. Finally, the pre-reduction graphene fiber is placed in the protective atmosphere of Ar and processed by heat treatment. The process temperature is heated to 1500° C. at 3° C./min and kept for 2 hours such that the graphene fiber is obtained.

### Experiment EX5

First, 10 g/mL of the graphitic oxide solution is injected into the solution containing 0.5 mg/m cetyltrimethylammonium bromide, 5 wt % calcium chloride and 2.5 mg/ml ascorbic at 10 ml/min through the wet spinning process. After 4 hours, the pre-reduction graphene fiber is solidified. The pre-reduction graphene fiber is filtered from the coagulation bath and dried at room temperature to remove the residual water. Then, the heat treatment is performed in the protective atmosphere of Ar. The processing temperature is heated to 1500° C. at 3° C./min and kept for 2 hours to obtain the graphene fiber.

From the test result, the electrical conductivity of the graphene fiber obtained in EX1-EX5 is within a range of 10⁻² to 10³ S/cm, the thermal conductivity within a range of 90 to 1000 W/mK, the elongation strength within a range of 100 to 1000 MPa, and the Young's modulus within a range of 1 to 10 GPa. Moreover, the ratio of length to diameter is greater than 10, preferably greater than 500. The graphene fiber is measured to examine the content of carbon and oxygen by the nitrogen analyzer and the carbon-sulfur analyzer. As a result, the ratio of carbon to oxygen is greater than 5, preferably 15 to 60.

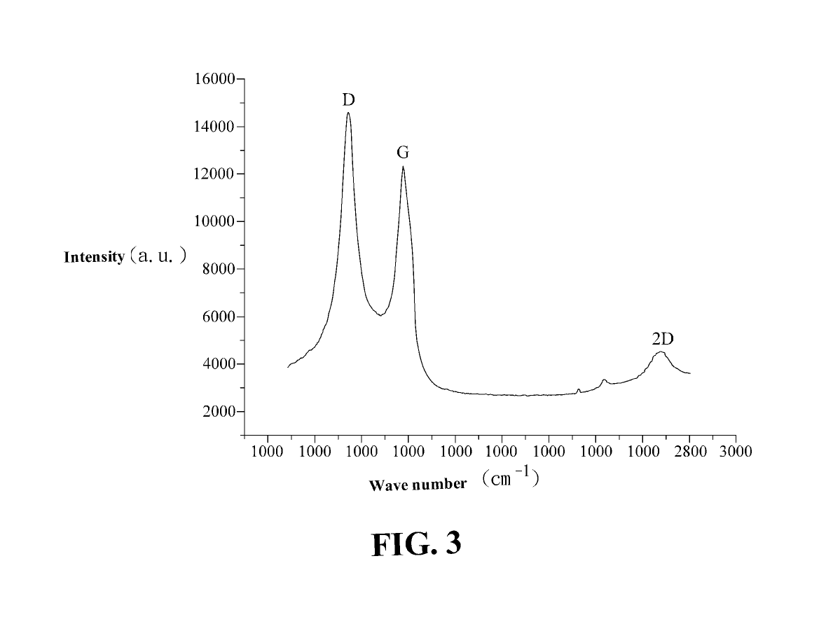

FIG. 3 shows the result of measuring the graphene fiber according to the present invention by the Raman spectrometry. As shown in FIG. 3, the structure of the graphene fiber is clearly identified by the intensity ratio (I_{D}/I_{G}) within a range of 0.5 to 1.5, and the G band intensity ratio (I_{2D}/I_{G}) within a range of 0.1 to 1.2.

From the above-mentioned, one aspect of the present invention is that the graphene fiber exhibits excellent mechanical strength, and thermal/electrical conductivities. In particular, the manufacturing process is performed by chemical oxidation-reduction in the solution such that the processing steps are simpler and the poisonous chemicals possibly generated at the working environment are greatly decreased. Therefore, the safety of the whole manufacturing process is improved, and the processing time and manufacturing cost are reduced.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A graphene fiber, comprising:
a plurality of graphene sheets enveloping an axis, coaxially stacked one by one from the axis and extended along the axis, each graphene sheet having a thickness less than 3 nm.

2. The graphene fiber as claimed in claim 1, further having a diameter less than 100 μm, a ratio of length to diameter greater than 10, and a ratio of carbon to oxygen greater than 5.

3. The graphene fiber as claimed in claim 1, further having electrical conductivity within a range of 10⁻² to 10³ S/cm, thermal conductivity within a range of 90 to 1000 W/mK, elongation strength within a range of 100 to 1000 MPa, and Young's modulus within a range of 1 to 10 GPa, and formed of a graphene structure under test by a Raman spectrometer with an ratio of intensity (I_{D}/I_{G}) within a range of 0.5 to 1.5, and a G band intensity ratio (I_{2D}/I_{G}) within a range of 0.1 to 1.2.

4. A method of manufacturing graphene fiber, comprising:
oxidizing a graphite material to form pieces of graphitic oxide;
dispersing the pieces of graphitic oxide in water to form a graphitic oxide solution with a concentration of graphitic oxide within a range of 1-10 mg/mL, the pieces of graphitic oxide in the graphitic oxide solution arranged in parallel to a direction of a long axis to form oxidized graphene sheets;
injecting the graphitic oxide solution into a second solution through a spinning process to cause the graphitic oxide solution to contact the second solution for at least 0.5 hour so as to perform a water pin spinning process or an electric spinning process, wherein the second solution contains at least one cationic surfactant, at least one kind of cation and at least one acidic reductant such that chemical bonds are formed between the graphene sheets to exhibit an effect of flocculation, a pre-reduction graphene fiber is formed in the second solution, and surfaces of the graphene sheets are parallel to an axis of the pre-reduction graphene fiber;
drying the pre-reduction graphene fiber to form a pre-reduction graphene fiber body; and
performing a heat treatment on the pre-reduction graphene fiber body in a protective atmosphere to implement a process of reduction so as to form a graphene fiber, wherein the graphene fiber has a diameter less than 100 μm, a ratio of length to diameter greater than 10, and a ratio of carbon to oxygen greater than 5.

5. The method as claimed in claim 4, wherein the graphite material is selected from a group consisting of at least one of natural graphite, expanded graphite, artificial graphite, graphite fiber, carbon nano-tube and mesophase carbon micro-bead.

6. The method as claimed in claim 4, wherein the cationic surfactant has two ends, one end having a hydrophobic group with a long carbon chain, and the other end having a hydrophilic group with at least one nitrogen atom, sulfur atom or phosphorus atom.

7. The method as claimed in claim 4, wherein the cationic surfactant is selected from a group consisting of at least one of cetyltrimethylammonium bromide, polyacrylamide, and dodecyl trimethylammonium chloride or any combination thereof.

8. The method as claimed in claim 4, wherein the cation is selected from a group consisting of at least one of potassium ion, sodium ion, calcium ion, zinc ion, magnesium ion, iron ion and ammonium ion, or any combination thereof.

9. The method as claimed in claim 4, wherein the acidic reductant is selected from a group consisting of at least one of ascorbic acid, citric acid, polyphenol, acetic acid, and halogen acid, or any combination thereof.

10. The method as claimed in claim 9, wherein the halogen acid is selected from a group consisting of at least one of hydrogen iodide and hydrogen bromide, or any combination thereof.

11. The method as claimed in claim 4, wherein the heat treatment is performed in a temperature range of 300-1500° C., and for a period of time in a range of 10 to 120 minutes, and the protective atmosphere is selected from a group consisting of at least one of helium, argon and nitrogen, or any combination thereof.
